(19) United States
(12) Patent Application Publication
(10) Pub. No.: US 2014/0216288 A1
(43) Pub. Date: Aug. 7, 2014

(54) CARBON NANOTUBE AND POROUS SUBSTRATE INTEGRATED ENERGETIC DEVICE

(71) Applicant: U.S. ARMY RESEARCH LABORATORY ATTN: RDRL-LOC-I, Adelphi, MD (US)

(72) Inventors: Luke Currano, Columbia, MD (US); Madan Dubey, South River, NJ (US); Ronald G. Polcawich, Derwood, MD (US)

(73) Assignee: U.S. Army Research Laboratory ATTN: RDRL-LOC-I, Adelphi, MD (US)

(21) Appl. No.: 13/760,422

(22) Filed: Feb. 6, 2013

(51) Int. Cl. C06B 45/14; F42D 1/04

(52) U.S. Cl. CPC C06B 45/14; F42D 1/04; B82Y 99/00
USPC 102/201; 149/15; 102/202.5; 977/742

(57) ABSTRACT

Embodiments of energetic devices are provided herein. In some embodiments, an energetic device may include a substrate having a plurality of pores formed in a portion of the substrate; a plurality of carbon nanotubes disposed proximate the plurality of pores such that a reaction within one of the plurality of pores or the plurality of carbon nanotubes initiates a reaction within the other of the plurality of pores or the plurality of carbon nanotubes; a solid oxidizer disposed in the plurality of pores and the carbon nanotubes; and an initiator to initiate a reaction within one of the plurality of pores or the plurality of carbon nanotubes.

### GOVERNMENT INTEREST

The invention described herein may be manufactured, used and licensed by or for the U.S. Government.

### FIELD OF INVENTION

Embodiments of the present invention generally relate to energetic devices.

### BACKGROUND OF THE INVENTION

Conventional energetic reactions typically rely on oxidation of a material, for example a carbon containing material, to provide an exothermic chemical reaction. However, the inventors have observed that due to the size and components necessary to provide a desired energetic yield, conventional energetics are limited with respect to flexibility or customization for various applications.

Thus, the inventors have provided embodiments of an improved energetic device.

### BRIEF SUMMARY OF THE INVENTION

Embodiments of energetic devices are provided herein. In some embodiments, an energetic device may include a substrate having a plurality of pores formed in a portion of the substrate, a plurality of carbon nanotubes disposed proximate the plurality of pores such that a reaction within one of the plurality of pores or the plurality of carbon nanotubes initiates a reaction within the other of the plurality of pores or the plurality of carbon nanotubes; a solid oxidizer disposed in the plurality of pores and the carbon nanotubes and an initiator to initiate a reaction within one of the plurality of pores or the plurality of carbon nanotubes.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts an energetic device in accordance with some embodiments of the present invention.

FIG. 2 depicts a portion of an energetic device in accordance with some embodiments of the present invention.

FIGS. 3-5 respectively depict side views of an energetic device, in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION OF THE INVENTION

Embodiments of energetic devices are provided herein. The inventive energetic devices advantageously provide ease of ignition, longer burning times, and increased heat, gas, and/or shockwave generation as compared to conventional energetics. In addition, the inventive energetic device advantageously provides increase flexibility with respect to customization and potential applications as compared to conventional energetics.

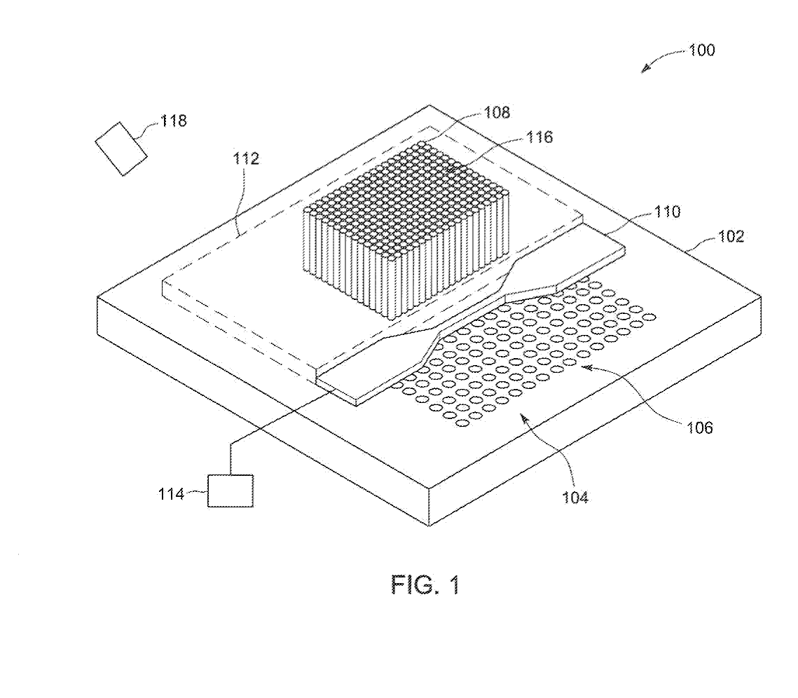

Referring to FIG. 1, in some embodiments, the energetic device 100 may generally comprise a substrate 102 having a plurality of pores 104 formed in a portion of the substrate 102 and a plurality of carbon nanotubes 108 disposed proximate the plurality of pores 104. The inventors have observed that by providing the substrate 102 having a plurality of pores 104 advantageously provides an ease of ignition while providing the carbon nanotubes 108 advantageously provides increased gas generation (e.g., carbon dioxide (CO₂) generation) and longer burning times (due to slower and more complete reactions) as compared to conventional energetics.

Under the appropriate conditions, carbon nanotubes are capable of ignition. However, the strength of such reactions are severely limited by the lack of availability of oxygen. Thus, the use of carbon nanotubes in energetic applications is generally limited to heat transfer devices or heat transfer scaffolding.

Accordingly, in some embodiments, the plurality of pores 104 and the plurality of carbon nanotubes 108 are filled with an oxidizer 106, 116. Alternatively, or in combination, in some embodiments, the oxidizer 116 may be disposed between adjacent nanotubes of the plurality of carbon nanotubes 108. When present, the oxidizer 106, 116 provides a sufficient amount of oxygen to facilitate complete or near complete energetic reactions within plurality of pores 104 and the carbon nanotubes 108, thereby resulting in a desired energetic yield. The oxidizer 106, 116 may be any oxidizer suitable to provide a sufficiently energetic reaction. For example, in some embodiments, the oxidizer 106 may comprise sodium perchlorate (NaClO₄), calcium perchlorate (Ca(ClO₄)₂), gadolinium nitrate (Gd(NO₃)₃), lithium perchlorate (LiClO₄), potassium nitrate (KNO₃), ammonium nitrate (NH₄NO₃), sulfur (S), hydrogen peroxide (H₂O₂), or the like. In some embodiments, the oxidizer 106 may be a solid state oxidizer.

The substrate 102 may be any type of substrate suitable to contain the oxidizer within the plurality of pores 104 formed in the substrate 102 and serve as an energetic fuel. For example, in some embodiments, the substrate may be a silicon or silicon-containing substrate.

In some embodiments, the substrate 102 may include a device 112 disposed on the substrate 102. The device 112 may be any type of device intended to interact with, or be destroyed by, the energetic device. For example, in some embodiments, the device may be a cap to confine gas or a nozzle to facilitate gas ejection. In another example, in some embodiments, the device 112 may be a microelectromechanical systems (MEMS) device. In such embodiments, the energetic device 100 may function to move a microscale piston of the MEMS device. In some embodiments, the device 112 may be an integrated chip. In such embodiments, the energetic device 100 may function to generate heat which that may be used to boil a liquid for chemical vapor analysis on the integrated chip. Alternatively, the energetic device 100 may function to generate a shock wave.

The plurality of pores 104 may be of any quantity and pore size suitable to accommodate a sufficient amount of oxidizer 106, 116 to provide a reaction having desired energy. For example, in some embodiments, the plurality of pores 104 may have a pore size of about 2 to about 30 nanometers, or in some embodiments about 2 to about 5 nanometers. In some embodiments, the pore size may be selected to control a speed of the reaction.

In some embodiments, an initiator may be utilized to initiate a reaction of the oxidizer 106, 116 disposed in the plurality of pores 104 or carbon nanotubes 108. The initiator may be any type of initiator suitable to initiate the reaction, for example, such as a bridgewire, exploding foil initiator, slapper detonator, or the like. For example, in some embodiments, a light source 118 (e.g., a high intensity light source) may be utilized to provide a high intensity light to the carbon nanotubes 108 to initiate or facilitate a reaction of the oxidizer 116 within the carbon nanotubes 108. In operation of such embodiments, the light source 118 causes the reaction of the oxidizer 116 within the carbon nanotubes 108, which in turn initiates a reaction of the oxidizer 106 within the plurality of pores 104 of the substrate 102.

Alternatively, or in combination, in some embodiments the initiator may be a conductive body disposed atop the plurality of pores 104 and configured to provide a current from a power source 114 to the plurality of pores 104 to initiate a reaction of the oxidizer 106 within the plurality of pores 104, for example such as the initiator 110 shown in FIG. 1. In operation of such embodiments, the initiator 110 causes the reaction of the oxidizer 106 within the plurality of pores 104, which in turn initiates a reaction of the oxidizer 116 within the carbon nanotubes 108.

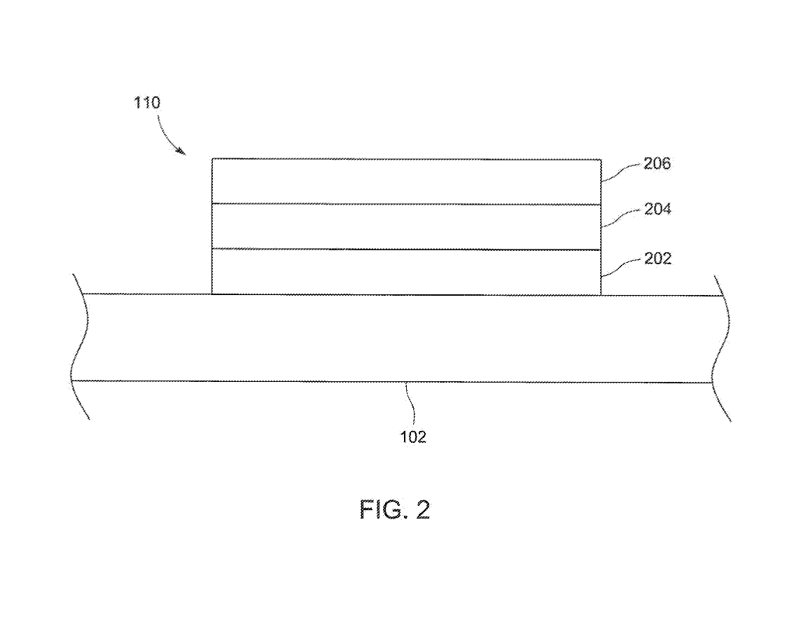

The initiator 110 may be fabricated from any conductive material suitable to provide a sufficient current to the plurality of pores 104 to cause the reaction. For example, in some embodiments, the initiator may be fabricated from a metal, such as gold (Au), copper (Cu), or the like. Referring to FIG. 2, in some embodiments, the initiator 110 may comprise a plurality of layers. For example, in some embodiments, the initiator 110 may have a first layer 202 comprising chrome (Cr), a second layer 204 comprising platinum (Pt) disposed above the first layer 202, and a third layer 206 comprising gold (Au) disposed above the second layer 204. Providing a chrome (Cr) first layer 202 may advantageously provide a sufficient level of adhesion to secure the initiator 110 to the substrate 102. Providing a platinum (Pt) second layer 204 advantageously provides a barrier to prevent a reaction between the gold (Au) third layer 206 and the substrate 102. Providing a gold (Au) third layer 206 facilitates initiation of the reaction at a low voltage due to the low resistivity of gold (Au).

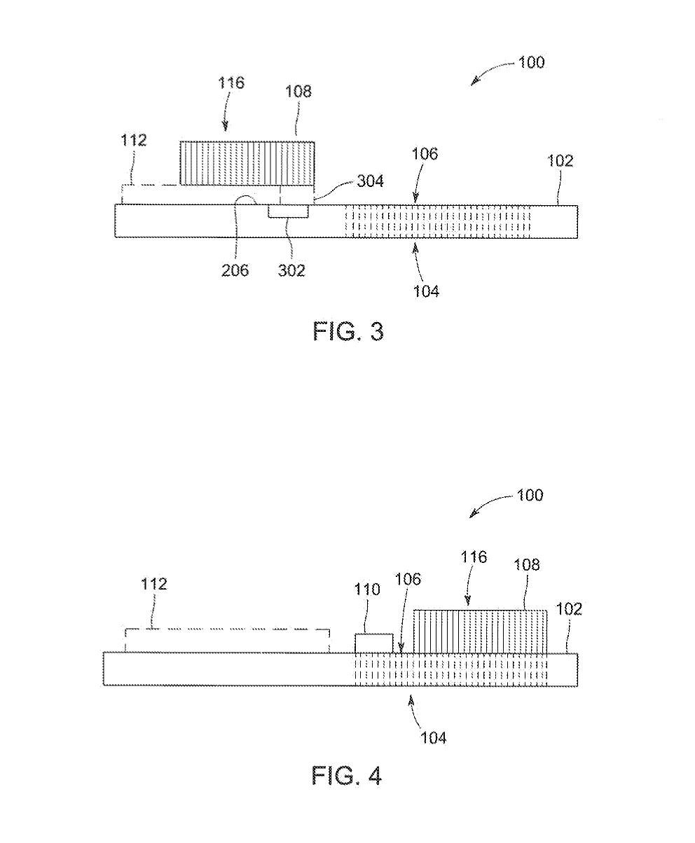

Although the initiator 110 is described above as disposed atop the plurality of pores 104, the initiator 110 may be disposed in any location suitable to initiate the reaction of the oxidizer 106, 116 disposed within the plurality of pores 104 or carbon nanotubes 108. For example, in some embodiments, the initiator 302 may be disposed beneath the carbon nanotubes 108 and embedded within a top surface 206 of the substrate 102, for example, such as shown in FIG. 3. Alternatively, in some embodiments, the initiator (shown in phantom at 304) may be disposed between the substrate 102 and the carbon nanotubes 108. In operation of such embodiments, the initiator 302, 304 causes the reaction of the oxidizer 116 within the carbon nanotubes 108, which in turn initiates a reaction of the oxidizer 106 within the plurality of pores 104 of the substrate 102.

The carbon nanotubes 108 may be disposed in any location with respect to the the plurality of pores 104 that is sufficiently close to allow a reaction within the plurality of pores 104 to cause ignition of the oxidizer 116 within the carbon nanotubes 108 or, alternatively, a reaction within the carbon nanotubes 108 to cause ignition of a reaction within the plurality of pores 104. For example, in some embodiments the carbon nanotubes 108 may be disposed atop the substrate 102 and adjacent to the plurality of pores 104, such as shown in FIG. 3. In such embodiments, the carbon nanotubes 108 may be disposed atop the device 112. Alternatively, in some embodiments, the carbon nanotubes 108 may at least partially overlap, or in some embodiments be disposed atop, the plurality of pores 104, such as shown in FIG. 4.

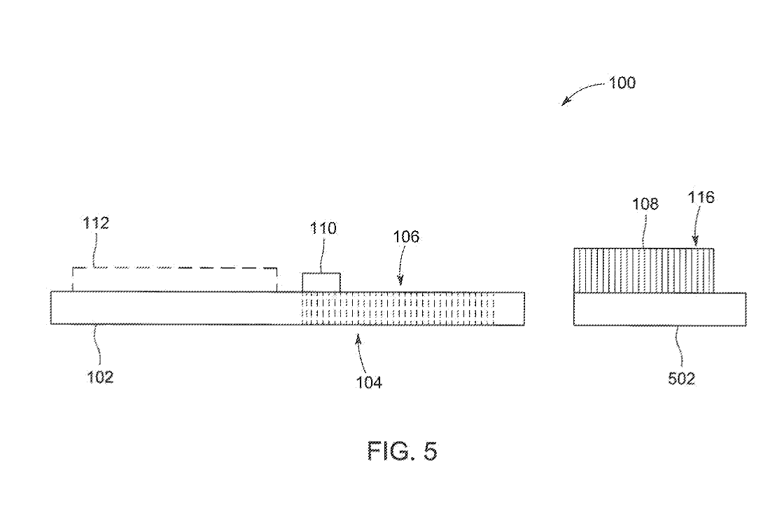

Referring to FIG. 5, in some embodiments, the carbon nanotubes 108 may be disposed atop an additional substrate 502. In such embodiments, the additional substrate 502 may be disposed in any location with respect to the the plurality of pores 104 that is sufficiently close to allow a reaction within the plurality of pores 104 to cause ignition of the oxidizer 116 within the carbon nanotubes 108. The inventors have observed that providing the carbon nanotubes 108 atop the additional substrate 502 allows for more flexibility of the use and placement of the energetic device 100. For example, in an application where the energetic device 100 may be utilized within an integrated circuit, limited space may prevent sufficiently close placement of a silicon igniter (e.g., the substrate 102 having the plurality of pores 104 filled with oxidizer 106) to the energetic device 100. In such an application, the additional substrate 502 having the carbon nanotubes 108 disposed thereon may be placed over the substrate 102 and ignited remotely via a reaction of the oxidizer 106 within the plurality of pores of the substrate 102.

Thus, energetic devices that advantageously provide at least one of ease of ignition, longer burning times, increased heat, gas, or shockwave generation, and increased flexibility with respect to customization and potential applications as compared to conventional energetics has been provided herein.

While the foregoing is directed to embodiments of the present invention, other and further embodiments of the invention may be devised without departing from the basic scope thereof.

1. An energetic device, comprising:
a substrate having a plurality of pores formed in a portion of the substrate;
a plurality of carbon nanotubes disposed proximate the plurality of pores such that a reaction within one of the plurality of pores or the plurality of carbon nanotubes initiates a reaction within the other of the plurality of pores or the plurality of carbon nanotubes;
an oxidizer disposed in the plurality of pores and the carbon nanotubes; and
an initiator to initiate a reaction within one of the plurality of pores or the plurality of carbon nanotubes.

2. The energetic device of claim 1, wherein the substrate is a silicon containing substrate.

3. The energetic device of claim 1, wherein the plurality of pores have a pore size of about 2 nanometers to about 30 nanometers.

4. The energetic device of claim 1, wherein the oxidizer comprises one of sodium perchlorate (NaClO₄), calcium perchlorate (Ca(ClO₄)₂), gadolinium nitrate (Gd(NO₃)₃), lithium perchlorate (LiClO₄), potassium nitrate (KNO₃), ammonium nitrate (NH₄NO₃), sulfur (S), or hydrogen peroxide (H₂O₂).

5. The energetic device of claim 1, wherein the oxidizer is a solid state oxidizer.

6. The energetic device of claim 1, wherein the oxidizer is disposed between adjacent carbon nanotubes of the plurality of carbon nanotubes.

7. The energetic device of claim 1, wherein the initiator is a light source configured to provide high intensity light to the carbon nanotubes.

8. The energetic device of claim 1, wherein the initiator is a conductive body configured to provide a current from a power source to one of the plurality of pores or the plurality of carbon nanotubes.

9. The energetic device of claim 8, wherein the initiator is disposed atop the plurality of pores.

10. The energetic device of claim 8, wherein the initiator is disposed between the plurality of carbon nanotubes and the substrate.

11. The energetic device of claim 10, wherein the initiator is embedded in a top surface of the substrate.

12. The energetic device of claim 8, wherein the initiator comprises a first layer comprising chrome (Cr), a second layer comprising platinum (Pt) disposed atop the first layer, and a third layer comprising gold (Au) disposed atop the second layer.

13. The energetic device of claim 1, further comprising a device configured to interact with, or be moved or heated by, the energetic device.

14. The energetic device of claim 13, where the device is a microelectromechanical systems (MEMS) device.

15. The energetic device of claim 13, wherein the device is an integrated circuit.

16. The energetic device of claim 13, wherein the device is disposed between the substrate and the plurality of carbon nanotubes

17. The energetic device of claim 1, wherein the carbon nanotubes are disposed atop the substrate in an area adjacent to the plurality of pores such that a reaction within one of the plurality of pores or the plurality of carbon nanotubes initiates a reaction within the other of the plurality of pores or the plurality of carbon nanotubes

18. The energetic device of claim 1, wherein the carbon nanotubes are disposed atop the plurality of pores.

19. The energetic device of claim 1, wherein the plurality of carbon nanotubes are disposed on an additional substrate and wherein the additional substrate is disposed proximate the substrate such that a reaction within one of the plurality of pores or the plurality of carbon nanotubes initiates a reaction within the other of the plurality of pores or the plurality of carbon nanotubes.

20. The energetic device of claim 1, wherein the additional substrate is a silicon containing substrate.
